(19) United States
(12) Patent Application Publication
(10) Pub. No.: US 2023/0186887 A1
(43) Pub. Date: Jun. 15, 2023

(54) Three Cell Folded Corner Horn

(71) Applicants: James Melvin Henson, Roscoe, IL (US); Russell Wayne James, Roscoe, IL (US)

(72) Inventors: James Melvin Henson, Roscoe, IL (US); Russell Wayne James, Roscoe, IL (US)

(21) Appl. No.: 17/826,118

(22) Filed: Jul. 9, 2022

Related U.S. Application Data
(60) Provisional application No. 63/276,841, filed on Dec. 10, 2021.

(51) Int. Cl. G10K 11/02; G10K 11/28; H04R 1/34

(52) U.S. Cl. CPC G10K 11/025; G10K 11/28; H04R 1/345

(57) ABSTRACT

This device consists of a hollow triangular pyramid shaped speaker mounting system that is divided into three cells. The device mounts into a corner of a structural space at the convergence of three plane surfaces such as two adjacent walls and the ceiling or the floor. The device would divide the acoustical waves from a speaker into three segments where diffusers would channel them into the pyramid toward the apex. A wave reverser would send the waves back toward the open base of the pyramid. When the three sound waves exit the device, they would merge and continue expanding along each of the three plane surfaces in the hosting structural space. Each segment of the sound waves would follow a path that takes the form of a folded horn. That would provide for a very large expansion of the sound waves coming from this device.

### INDEX OF FIGURES

FIG. 1 Enclosure Wall: Three of these items would be joined along the shorter dimensions to form an empty triangular pyramid with an open base.

FIG. 2 Apex of the pyramid: A photograph illustrating the apex of the pyramid with the three Enclosure Walls joined.

FIG. 3 Outside of the Enclosure: A photograph that illustrates the joining of the Enclosure Walls to form the empty triangular pyramid.

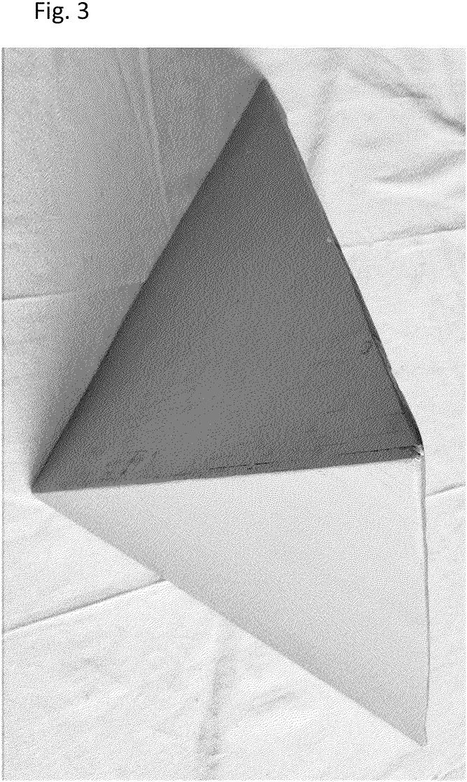

FIG. 4 Divider: This component is installed inside the empty pyramid in order to divide the pyramid into three cells.

FIG. 5 Three Dividers (FIG. 4) in the pyramid: A photograph depicting the three Dividers inside the Enclosure.

FIG. 6 Wave Reverser: a component that would reverse the direction of travel of the sound wave generated by a speaker.

FIG. 7 Wave Reverser in the Pyramid: The Wave Reverser (FIG. 6) is shown in this photograph near the apex of the pyramid.

FIG. 8 Diffuser Front: This item is an outer surface of the Diffuser Subassembly (FIG. 11) and is the surface that will be joined to the Speaker Mount (FIG. 12) in a manner to be determined by the builder

FIG. 9 Diffuser Side: Two of these components would form part of the Diffuser Subassembly (FIG. 11).

FIG. 10 Diffuser Top: This component would be connected on the upper edges of the Diffuser Sides (FIG. 9) opposite the Dividers (FIG. 4). This would serve to finish enclosing three somewhat tubular channels that would accept the audio wave from a commercially available audio speaker positioned on and fastened to the Speaker Mount.

FIG. 11 Diffuser Subassembly: This photograph shows the completed Diffuser Subassembly before installation in the pyramid.

FIG. 12 Speaker Mount: This component is centered on and attached to the three Dividers at the geometric center of the pyramid. It could be formed using plastic or wood or other appropriate material. In the center there is a circular opening that would match and align with the outer diameter of the speaker cone.

FIG. 13 Wave Path through the Pyramid: A photograph that provides a view of the path of the acoustic wave through the Speaker Mount into the Diffuser Subassembly and onto the Wave Reverser.

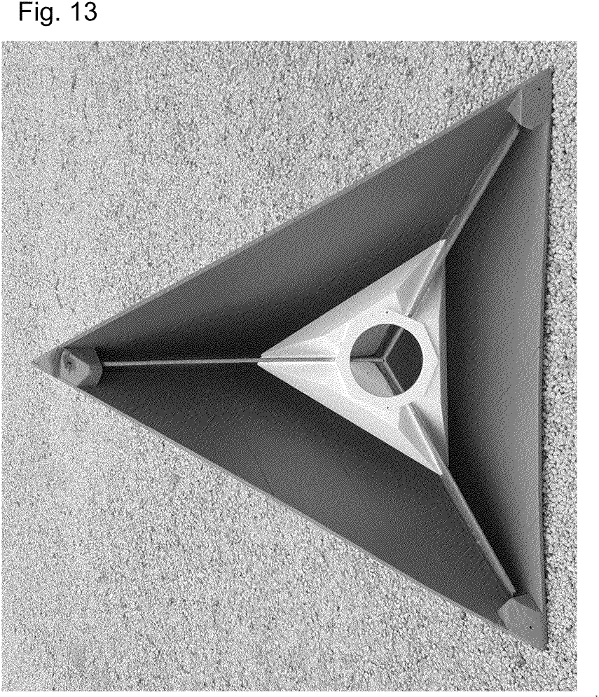

FIG. 14 Completed Model: A photograph of the completed model of this device.

### OVERALL SPECIFICATION

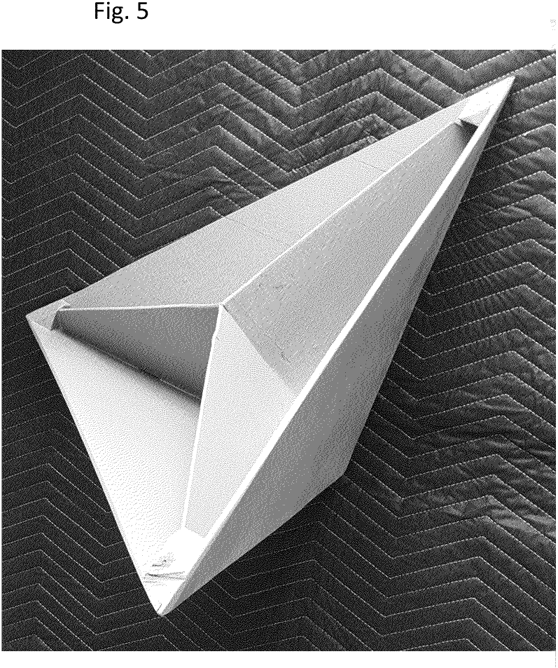

This speaker adaptation device consists of a hollow triangular pyramid shaped speaker mounting system that is divided into three cells. (FIG. 5) The internal components within each cell would essentially control the direction of travel of each of segment of the audio wave. The design of this aspect of the structure is intended to direct about one third of the audio wave toward the apex of the pyramid within each of the three cells. The device mounts into a corner of a structural space at the convergence of three plane surfaces. An example would be two adjacent walls and the ceiling in a room. A similar approach would use two walls and the floor. The device would divide the acoustical wave from a speaker into three segments.

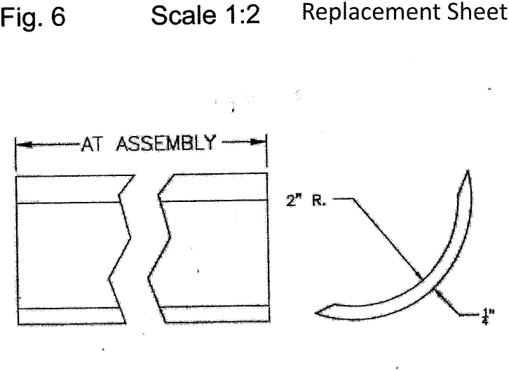

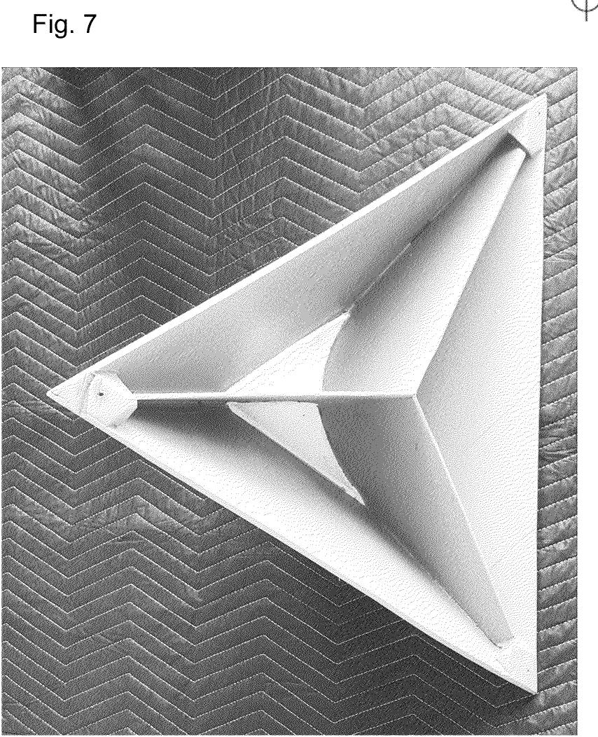

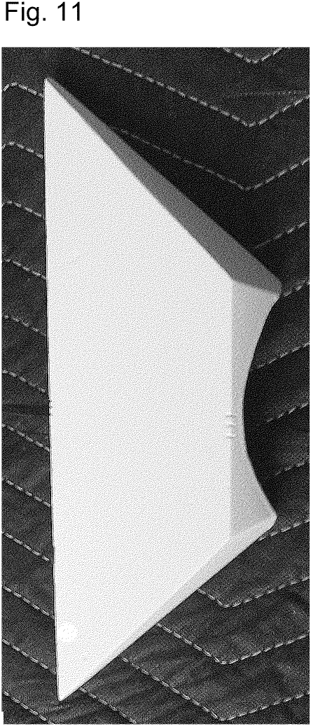

Three Diffuser Subassemblies (FIG. 11) would serve to channel the sound waves into the pyramid toward the apex where a Wave Reverser (FIG. 6) would essentially reverse the travel of the sound waves back toward the open base of the pyramid. (FIG. 7) That would in effect direct each segment of the sound wave along a path that takes the form of a folded horn.

When a sound wave exits the device at the open base, it would be expected to merge with the other two wave fronts and continue expanding along each of the three plane surfaces in the hosting structural space. This guided wave front within this device is integrated with the three plane surfaces of the hosting structural space. That would provide the configuration needed for a very large controlled expansion of the sound wave in this folded corner horn when compared to the size of an equivalent linear acoustical horn.

### CONSTRUCTION OF WORKING MODEL TO DEMONSTRATE A PROOF OF CONCEPT

The following will describe the components and processes needed to construct a working model of this proposed device. The purpose is to provide a physical illustration of the conceptual device.

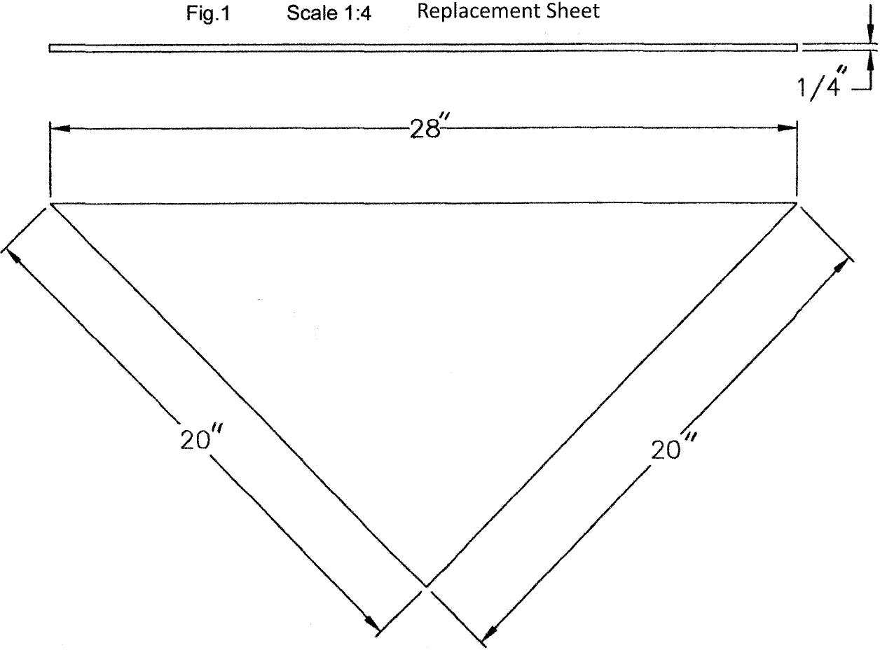

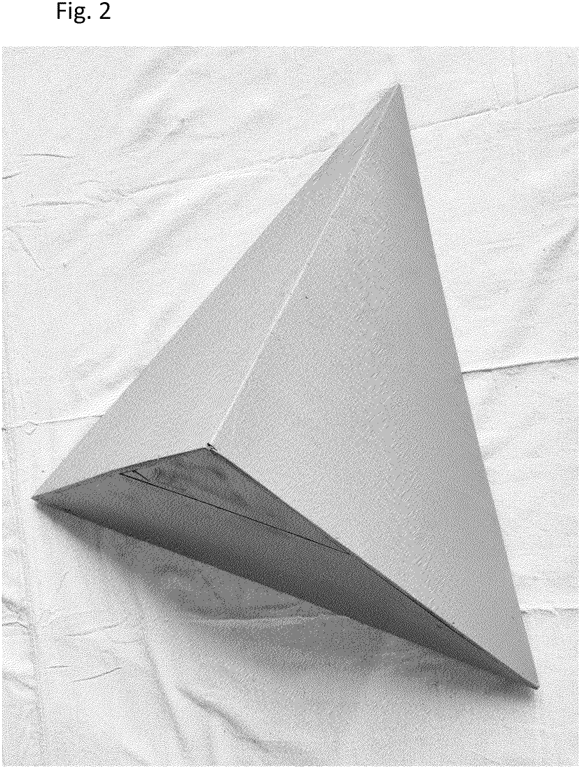

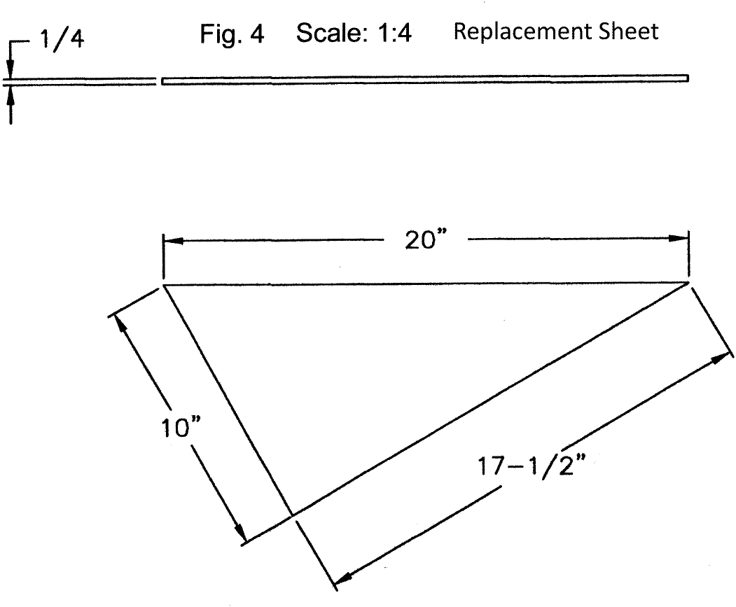

The enclosure of the device can be constructed using three pieces of triangular solid sheet material (FIG. 1) such as wood to form a hollow pyramid with an open base. The enclosure is constructed in a manner that adapts to the design of the hosting structural space. If all three surfaces of the hosting structural space meet at 90 degree angles, then the enclosure could be a regular isosceles pyramid (FIG. 2). Other conditions within the hosting structural space would require adjustments in the enclosure dimensions. The inside of the pyramid is divided into three equal cells by the insertion of three triangular Dividers (FIG. 4) that encloses the area between the joints of the Enclosure Walls (FIG. 1) and the geometric center of the pyramid. (FIG. 5) One edge of the Dividers would generally lie on the hypothetical base of the pyramid. A junction of two edges of each of the Dividers would lie at the apex of the pyramid. It would be expected that the Dividers would need to be trimmed to fit the openings in the pyramid.

A curved Wave Reverser (FIG. 6) is located near the apex of the pyramid at the bottom of each of the three cells. (FIG. 7) This model uses a section of plastic material taken from a 4 inch diameter plastic pipe. Other shapes could be constructed using flat or curved material joined in appropriate angles as desired by the constructor. The concave side of this Wave Reverser is facing away from the apex and toward the open base of the pyramid. The purpose of the Wave Reversers is to provide a surface that reverses the direction of travel for the sound wave that is generated by a commercially available and suitable round speaker. The speaker would be mounted as described in a subsequent paragraph.

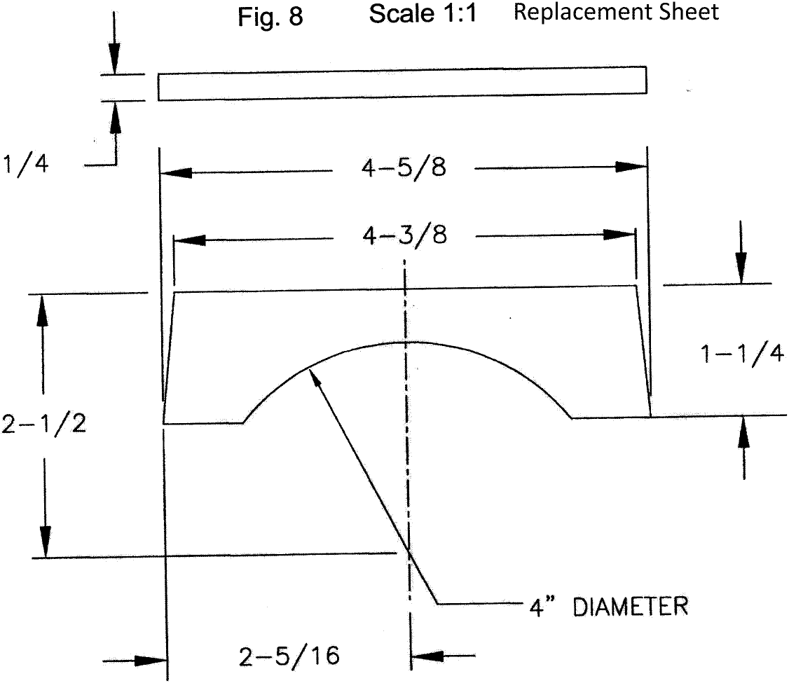

A circular Speaker Mount (FIG. 7) is centered on and attached to the three Dividers (FIG. , 5) at the theoretical base of the pyramid. The center of the circular opening of the Speaker Mount is aligned with the geometric centerline of the pyramid. This component could be formed using plastic or wood or other appropriate material. The center is a circular opening that would match and align with the outer diameter of the speaker cone. The outer dimensions and the shape of the Speaker Mount can vary since that is an inactive aspect of this component. It would need to be robust enough to support and anchor the speaker. It would also provide a mounting point for the Diffuser Subassembly (FIG. 11) at the Diffuser Front (FIG. 8). The Speaker Mount could be constructed with a shoulder to accommodate the attachment of a Diffuser Subassembly. Or, other attachment methods could be employed such as screw fasteners or adhesives.

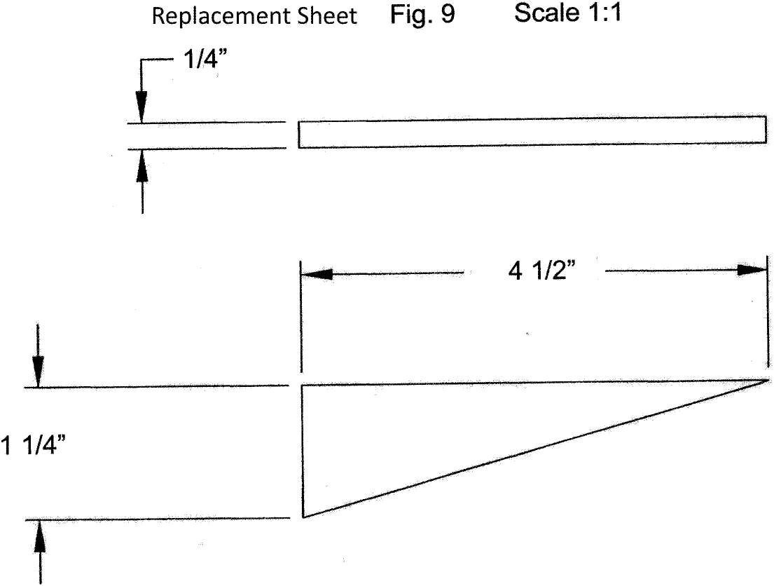

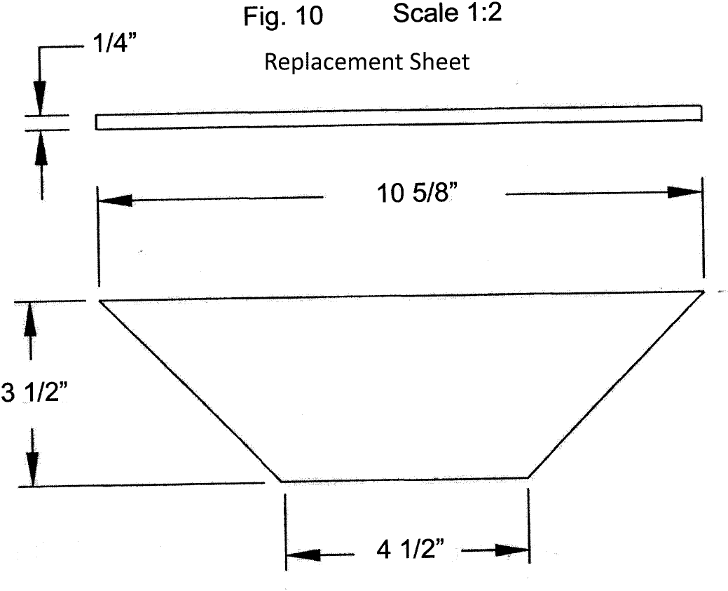

Three audio wave Diffuser Subassemblies (FIG. 11) should be constructed by first determining the preferred dimensions for the Diffuser Top. The smallest dimension (excluding the thickness dimension) should comport with the longest straight side of the Diffuser Front (FIG. 8) after trimming as needed. The two Diffuser Sides (FIG. 9) would be joined to the Diffuser top (FIG. 10) with the shortest side of the Diffuser Sides mated to the shortest dimensions (excluding the thickness dimension) of the Diffuser Front (FIG. 8). The individual components and the completed Diffuser Subassembly (FIG. 11) would need trimming and shaping to fit the “as built” dimensions of the cell structures and the intent of the builder.

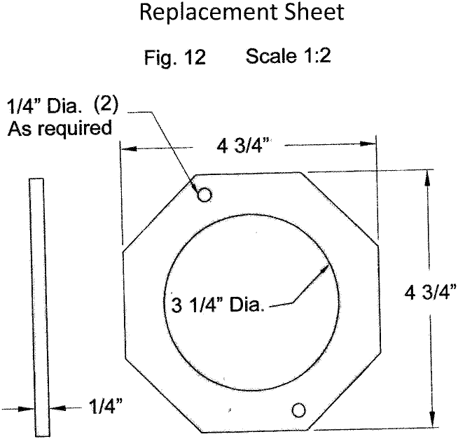

Each Diffuser Subassembly (FIG. 11) would be connected to the Speaker Mount and to two of the Dividers (FIG. 5) in order to form a path for each of the three audio waves to follow within a cell. The purpose of the Diffuser Subassembly is to form an open ended tubular channel that directs the sound wave from the speaker on the Speaker Mount (FIG. 12) down into the enclosure along the surfaces of the Dividers (FIG. 5) toward the Wave Reversers (FIG. 7) near the apex of the pyramid. The Diffuser Subassemblies (FIG. 11) for this model would be is constructed using a simple wood design. Other approaches could include molded plastic shapes, formed metal channels, or other composite materials.

A commercially available round audio speaker would be centered and mounted above the Dividers (FIG. 5) facing downward into each of the three cells within the pyramid. The speaker utilized in this model has a 3 inch diameter cone.

An oblong speaker could also be accommodated, but the dimensions and the symmetry of the pyramid would require some adjustments. This might come into play when there is a need to accommodate a corner in a host structural space that is not symmetrical and does not have three equal angles for the three plane surfaces. That issue would suggest the need to address the angles, dimensions, and the shape of a suitable pyramid for that corner in the hosting structural space.

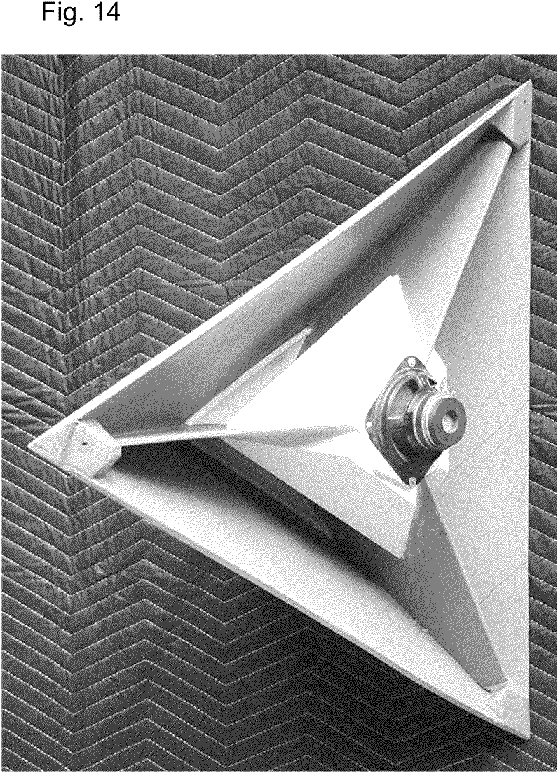

The back side of the speaker is left unobstructed as shown in the Completed Model (FIG. 14) or it could be enclosed in an acoustically transparent covering. This would create a situation where the speaker cone is front-loaded by the large acoustical horn provided by this device in conjunction with the plane surfaces of the hosting structure while the reverse side of the speaker cone is not impeded beyond the normal atmosphere.

### USING THE DEVICE

It is expected that the installer of this device would usually select a location in the hosting structural space that is compatible with the design of the device. However, the device could be designed and constructed in a manner that would conform to the requirements needed for an existing structural space. That might include unequal angles and varying dimensions for the enclosure Walls (FIG. 1).

In order to obtain the benefits that might be expected with the utilization of this device, three unobstructed plane surfaces that converge in a corner at the installation area would be preferred. Whenever appropriate, the device should be fully integrated into the hosting structural space. That might include blending and smoothing where different surfaces meet and could also include embedding the device into the structural elements of the hosting structural space such as wall construction. The Enclosure Walls (FIG. 1) might replace portions of the existing drywall or paneling as examples.

The Completed Model (FIG. 14) in this example utilizes a readily available 3 inch round speaker. Other sizes and shapes could be utilized instead, but that would necessitate additional accommodations such as a larger Speaker Mount (FIG. 12) with the commensurate Diffuser Subassemblies (FIG. 11). Other shapes such as an oblong (6 × 9) speaker would require extensive adjustments in several aspect of the construction.

The speaker in this device would need to be connected to a source of a compatible audio signal through physical conductors from an audio amplifier, electromagnetic signals from a Bluetooth device, or other methods. Those aspects of the use of this device are outside the scope of this design.

1. This device would represent an enhancement and an expansion of existing audio speaker accommodation designs that are free standing as well as others that might utilize only two adjacent plane surfaces of a structural space such as two walls. This approach would allow the device to utilize three adjacent plane surfaces within a structural environment to act as a large acoustical horn.
a. By utilizing three large plane surfaces of the hosting structural space, the device could likely be formulated to increase the fidelity and the perceived energy level of the speaker. The utilization of the three extended and guided acoustical paths obtained with this device could provide a more robust and cohesive wave front.
b. The elements of this design could also be tailored to counteract deleterious effects related to shortcomings of the chosen speaker such as distortion based on the inherent resonant frequency of the cone.
